(19) United States
(12) Patent Application Publication
(10) Pub. No.: US 2009/0154943 A1
(43) Pub. Date: Jun. 18, 2009

(54) ON DEMAND FUSER AND RELATED METHOD

(76) Inventors: Andrew Ciaschi, Pittsford, NY (US); Joseph A. Manico, Rochester, NY (US)

Correspondence Address: David A. Novais;Patent Legal Staff, Eastman Kodak Company, 343 State Street, Rochester, NY, 14650-2201, US

(21) Appl. No.: 11/954,444

(22) Filed: Dec. 12, 2007

(51) Int. Cl. G03G 15/00; G03G 15/20

(52) U.S. Cl. 399/45; 399/67; 399/329; 399/341

(57) ABSTRACT

A variable shaped heated fusing member for fusing toner to sheets of receiver media with one or more support members in contact with said heated fusing member such that the contact member is capable of changing said fuser member shape as determined by a suitable manual input or electronic analysis of the image.

### FIELD OF THE INVENTION

This invention relates in general to an electrophotographic printing system and more specifically to an on demand fusing apparatus and method for fusing the final print using a heated fusing member for fusing toner to sheets of receiver media over a wide range of gloss controls by changing the fuser member contact area.

### BACKGROUND OF THE INVENTION

Early electrophotographic copiers used a hard metallic fusing roller covered with a fluorocarbon, which imparted an undesirably glossy finish to what was nearly 100% textural material. Later copiers used a silicone rubber fusing roller, which provided a more matte finish to the text, which generally has been considered more desirable.

As electrophotography has become more and more capable of reproducing pictorial subject matter, especially in three or four colors in addition to a clear toner, a desire for a more glossy appearance is needed. Accordingly, hard metallic fusing surfaces are used and toners are formulated and designed for glossy reproduction for image forming apparatus designed for high quality color pictures. At the same time, users of office copiers dealing primarily with textural material or graphics continue to prefer a more matte finish.

Also the need for on-demand functionality requires the development of a more energy efficient, quicker starting, lower cost, and more reliable fusing processes, that can deliver the proper image quality, in electrographic printing devices, has been practiced since the beginning of electro-photography (EP). The following concept is striving for the same improvements over today's current state of the art, of fusing.

To meet the proper image quality in today's market, control of the image gloss, luster and other surface finishes has become more important. The ability to match the media surface gloss for all image color densities as closely as possible, determines the level of image quality with respect to the fusing process. A user selectable gloss level and coverage is also needed to satisfy end user demands. The differences between high (glossy) photo quality gloss, medium graphic arts quality gloss, and low (matte) text quality gloss are large and have been unattainable using prior art printers and current printing methods. The present invention attains this range of capability from one fusing system, while maintaining a low differential gloss.

### SUMMARY OF THE INVENTION

This invention is directed to an electrophographic printing system and more specifically to an on-demand apparatus and method for fusing a final print using a variable fusing member with independent variable heating and cooling capabilities for different contact areas for heating and/or cooling areas respectively as determined by a suitable manual input or electronic analysis of the image.

### BRIEF DESCRIPTION OF THE DRAWINGS

For a better understanding of the characteristics of this invention the invention will now be described in detail with reference to the accompanying drawings.

FIG. 1 is a schematic view of an electrostatographic reproduction apparatus.

FIG. 2 is a side view showing a portion of the fusing apparatus of FIG. 1.

FIG. 3 is an exploded view of a fusing apparatus FIG. 4 is similar to FIG. 3 but illustrates an embodiment in which the FIG. 3 method has been modified.

FIG. 5 is a view showing portions of the fusing apparatus of FIG. 1.

FIG. 6 is a graph of the relationship between gloss and cooling length for the fusing apparatus of FIG. 5.

FIG. 7 illustrates a method of use for the fusing apparatus of FIG. 1.

### DETAILED DESCRIPTION OF THE INVENTION

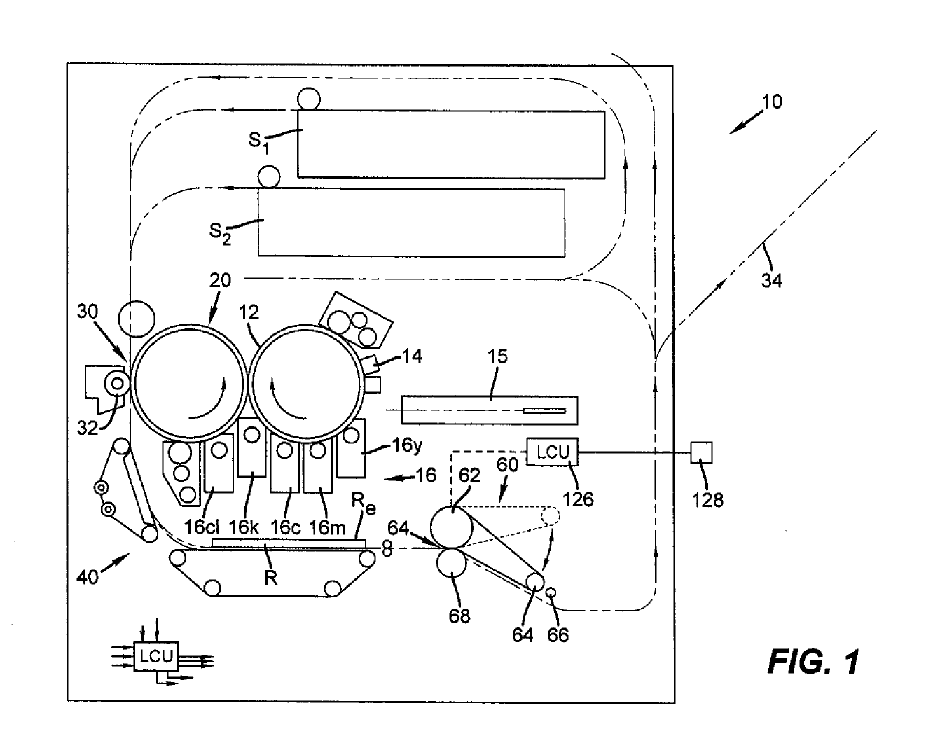

Referring now to the accompanying drawings, an electrostatographic reproduction apparatus, designated generally by the numeral 10, is shown in FIG. 1. The reproduction apparatus 10 includes a primary image forming dielectric member, for example, a drum 12 having a photoconductive surface, upon which a pigmented or dye marking particle image, or series of different color marking particle images, is formed. In order to form images, when the photoconductive drum 12 is rotated in the direction of the arrow associated therewith, the photoconductive surface of drum is uniformly charged, and then exposed imagewise by, for example, a laser or light emitting diode (LED) array 15, to create a corresponding latent electrostatic image. The latent electrostatic image is developed by an application of pigmented marking particles to the image-bearing drum 12 by a development station 16, in the manner more fully described in U.S. Pat. No. 5,841,039, incorporated herein by reference.

In the embodiment of the reproduction apparatus 10 as shown, there are five developing units, each unit having particular different color marking particles associated respectively therewith. Specifically, developing unit 16y contains yellow marking particles, developing unit 16m contains magenta marking particles, developing unit 16c contains cyan marking particles, and developing unit 16k contains black marking particles. Of course, other color marking particles (e.g. red, green, blue, etc.) may be used in the particular developing units depending upon the overall arrangement of the development station 16 and operational characteristics of the color development scheme for the reproduction apparatus 10. Additionally, a developing unit 16cl is provided, containing clear marking particles, which is utilized to aid in improving the quality and gloss of reproduced images, in the manner more fully described in the U.S. Pat. No. 5,841,039.

Each developer unit is separately activated for operative developing relation with drum 12 to apply different color marking particles respectively to a series of images carried on drum 12 to create a series of different color marking particle images. The developed marking particle image is transferred (or multiple marking particle images are transferred one after another in registration) to the outer surface of a secondary or intermediate image transfer member, for example, an intermediate transfer drum 20. Thereafter, the single marking particle image, or a multicolor image comprising multiple marking particle images respectively formed on the surface of the intermediate image transfer member drum 20, is transferred in a single step to a receiver member.

The receiver member is transported along a path (designated by chain-link lines) into a nip 30 between intermediate image transfer member drum 20 and a transfer-backing member, for example a roller 32. The receiver member is delivered from a suitable receiver member supply (hopper S₁ or S₂) into nip 30 where it receives the marking particle image. The receiving member exits the nip 30, and is transported by transport mechanism 40 to an on demand fuser assembly 60 with multiple positions and shapes as shown in FIG. 1 and further described in detail below. The fuser tacks, also referred to as fusing, the marking particle image to the receiver member by the application of heat and/or pressure. After tacking the image to the receiver member, the receiver member is selectively transported to return to the transfer nip 30 to have a second side (duplex) image transferred to such receiver member, to a remote output tray 34 for operator retrieval, or to an output accessory.

Appropriate sensors (not shown) of any well known type, such as mechanical, electrical, or optical for example, are utilized in the reproduction apparatus 10 to provide control signals for the apparatus. Such sensors are located along the receiver member travel path and are associated with the primary image forming member photoconductive drum 12, the intermediate image transfer member drum 20, the transfer backing member roller 32, and various image processing stations. As such, the sensors detect the location of a receiver member in its travel path, and the position of the primary image forming member photoconductive drum 12 in relation to the image forming processing stations, and respectively produce appropriate signals indicative thereof. Such signals are fed as input information to a logic and control unit L including a microprocessor, for example. Based on such signals and a suitable program for the microprocessor, the unit L produces signals to control the timing operation of the various electrographic process stations for carrying out the reproduction process. The production of a program for a number of commercially available microprocessors, which are suitable for use with the invention, is a conventional skill well understood in the art. The particular details of any such program would, of course, depend on the architecture of the designated microprocessor.

Under certain conditions for desired particular reproductions, as discussed in U.S. Pat. No. 5,841,039, during operation of the reproduction apparatus 10, first the developer unit 16cl lays down layer of clear marking particles on the intermediate transfer drum 20 corresponding to an area substantially equal to the area of a receiver member. Thereafter, color separation latent image charge patterns formed by the writer 15 on the drum 12 are developed with respective color marking particles and transferred in superposed registration to the intermediate transfer drum 20 (already bearing the clear marking particle layer). Then the combination marking particle image is transferred to a receiver member, such as a coated sheet of paper, delivered to the transfer nip 30 from the selected supply hopper. After transfer of the multi-color image with the clear overcoat to the coated paper, the transport mechanism 40 delivers the paper to the on demand fusing device 60, where a gloss finish is imparted to the image.

The clear marking particle layer forms an overcoat which will substantially reduce image relief, produces a more uniform gloss appearance, and protects the reproduced images from various keeping and handling hazards such as finger prints, scratches, water spills, color fades due to UV exposures, vinyl offsets, and many others. However, it has been noted that during the fusing process of such marking particle images, marking particle offset sometimes still occurs, particularly to the heated fusing roller near the edges of the receiver member. According to this invention, it is proposed that the lay down of the clear marking particles CL be affected such that the coverage uniformly decreases towards the edges Rₑ of the receiver member R as shown schematically in FIG. 1. As a result, the marking particle offset problem is substantially eliminated, especially when the fusing member is a metal or plastic belt.

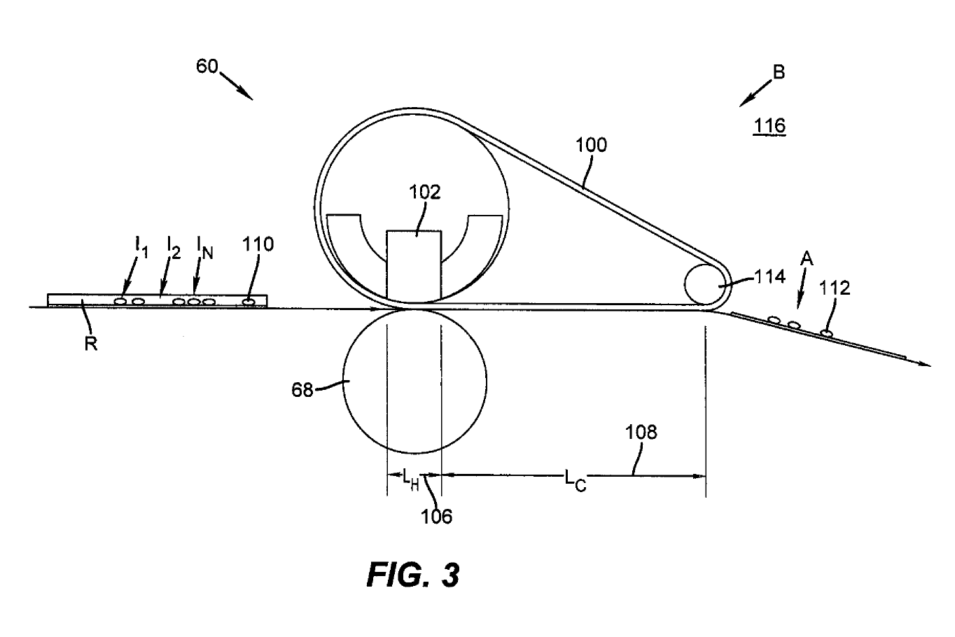

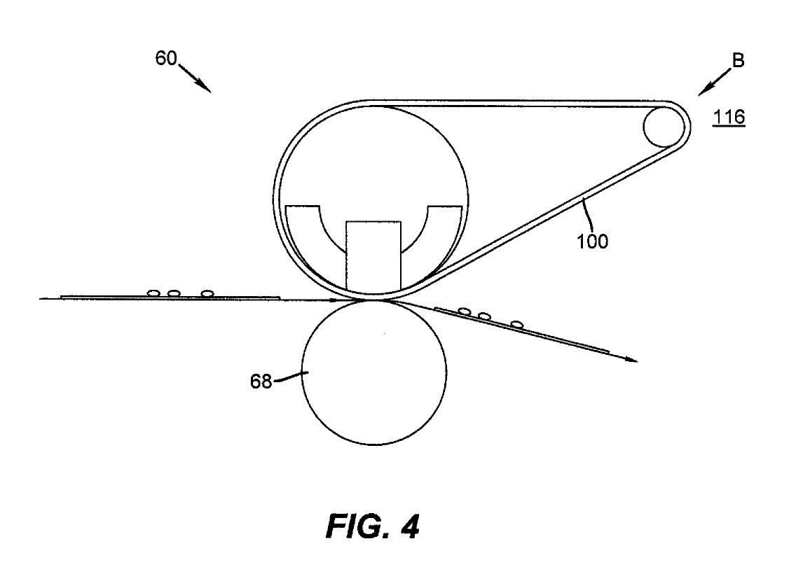

One embodiment of the on-demand fuser 60 of the present invention is shown in more detail FIG. 3 and discussed below with fuser support roller 62 and a second support roller 64 as well as one or more path roller 66. The fuser 60 is fast acting and addresses the issues of energy efficiency, quick starting, low cost with high value, and adequate reliability, that can deliver the proper image quality for photos, text, and graphics. The on-demand fuser can be used in the smaller printer described above or in larger commercial printers and can be in line or an offline, separate device.

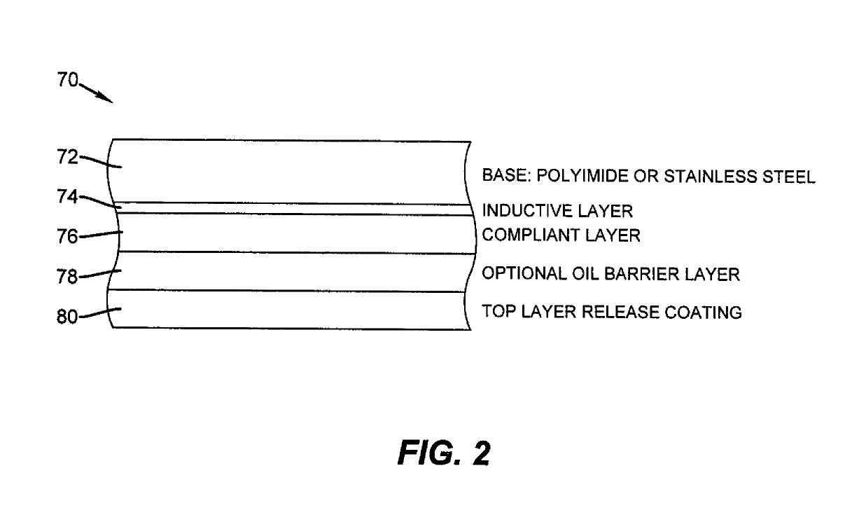

The basic architecture of the fuser includes a heated film 70 as shown in FIG. 2, also sometimes referred to as a belt or web, type body that with an elastomer covered backup roller 68, forms a pressure nip 64. The film 70, in one embodiment has a base 72 with an inductive layer 74, a compliant layer 76, an optional oil barrier layer 78 and a top release-coating layer 80. There is a heating zone formed by the contact area in the formed pressure nip that can be varied for variable heating times without changing process speed discussed below. There is also a cooling zone formed by the contact area in the formed pressure nip that can be varied for variable cooling. One or both of these contact areas can be engaged or disengaged as needed. For example the cooling can be bypassed altogether for dramatic large range gloss control that would take into account media type and the desired finish or gloss.

The film construction (shown in FIG. 2), as well as the position of the film body, can be used to position the heating zone within the film body near the toner fusing surface for fast acting highly efficient thermal application, for use with films that have elastomer layers, which are positioned between the fusing surface and film substrate, thicker than around 260 microns, and inductive heating systems. For films less than 2000 microns in thickness, which includes all elastomer layers and the substrate, a low mass heater can be used to heat the backside of the film.

FIG. 3 shows the on demand fuser 60, sometimes referred to as the fusing member, in a photo-centric position indicated by the “A” position. A fusing film 100 processes the toner image by imparting a surface finish while sintering and fixing the toner to the media. The film tracking can be active or passive. If the film circumference is small enough edge tracking, or other tracking devices, such as tongue and grooves can be used. These can be active systems controlled by a controller or a self-guided system guided by a boundary for instance. Heating assembly 102 heats the receiver after the toner is laid down. The one illustrated in FIG. 3 is an inductive type heater. This can be used to heat the backside (non-imaging side) of the film, or it can be used to heat an inductive (electrically conductive) layer within the film itself. Other heating elements can be used for backside heating, resistive elements in ceramic and other substrates. The receiver can be any material such as paper, plastics, metals, ceramics, fabrics and other materials of varying thicknesses and types that can be printed on.

FIG. 3 shows a possible embodiment of a fusing apparatus with an inductive heating layer. A nip forming pressure roller 68 that provides fusing pressure on the toner and partially determines the length of the heating zone, which is directly related to fusing dwell (or time of heating). The heating zone is also influenced by the shape of the heating assembly 102 and other related factors. A heating zone 106 is formed by the nip forming pressure roller. A cooling zone 108 is the area where the toner is cooled to near its Tg (glass transition temperature) for locking in a photo quality surface finish (with high gloss). Cooling means can be thermal electric, vapor phase change (heat pipes), or forced cool air, etc. Un-fused toner 110 on the receiver is shown here as sheet media. Fused toner 112 on the receiver is fixed and surfaced toner on the sheet media exiting the fusing process at a sliding structure or release roller 114. The on-demand fuser 60 is alternately shown in FIG. 3 in a position B for the release roller and film when switched into the text and graphics mode 116.

The photo-centric mode (see position A in FIG. 3) utilizes a heating and cooling process while the toner image is cast against the film surface. The heating process heats the toner to a sufficient temperature so that in combination with the pressure from the pressure roller the toner sufficiently softens to flow and mold itself to the film surface topography, and fix the toner to the media surface. The cooling zone allows the toner to cool to near its glass transition temperature where the cohesive strength is greater to overcome the adhesive forces of the film, and to remain on the media after release (or stripping) from the film. This process can yield gloss, at a 20 degree impingement angle, of near 100 (with smooth hard films). But, smooth hard films have very little micro-compliance around toner particles so the edges tend not to be fused very well, neither do the lower area mass lay-down areas, leaving a lower gloss. These effects tend to cause line type offset (LTOS).

LTOS can be avoided by using clear toner to level the imaging field to the highest toner stack by adding clear toner to the low mass lay-down areas (this is referred to as an inverse mask). This can be done by adding a 5th toning station with clear toner. Another solution is to use a compliant film that conforms to the toner particles. This solution does not have the same capability to produce high glosses near 100 (G20), but can avoid LTOS, and eliminates the need for clear toner as low lay-down area filler. A compliant film can also help avoid image artifacts such as pinholes and voids due to non-conformance around the toner particles (and stacks).

In a document-centric mode, as shown as position B in FIG. 4, referred to hereafter as the text and graphics mode, is a position where the printer only utilizes the heating zone. The cooling zone is not necessary when photo quality high gloss prints are not requested. When this mode is needed the release roller moves to a position 116, shown in FIG. 3, that bypasses the cooling zone. In this case the toner releases from the film while still in a hot softened state. To facilitate a good clean release several methods could be employed. The most common method is to use a mold release agent (usually Silicone oil). Another method is to use a toner that has a wax release agent incorporated into it to reduce the attractive surface energy. This is referred to as oil-less toner. Another aspect of release is the mechanical geometry of the pressure nip exit. The sharper the radius at the exit the larger the release force (or peel rate); thus forcing the toned image off the film surface. Any or all of these methods could be used. The hot release does not solidify the toner as a cast surface of the fusing film. The toner will rebound after release, which causes the loss of the cast surface. The toners relaxation rate is slower than the fusing process, therefore leaving residual stresses that cause the rebound. This effect reduces the ability to attain very high gloss.

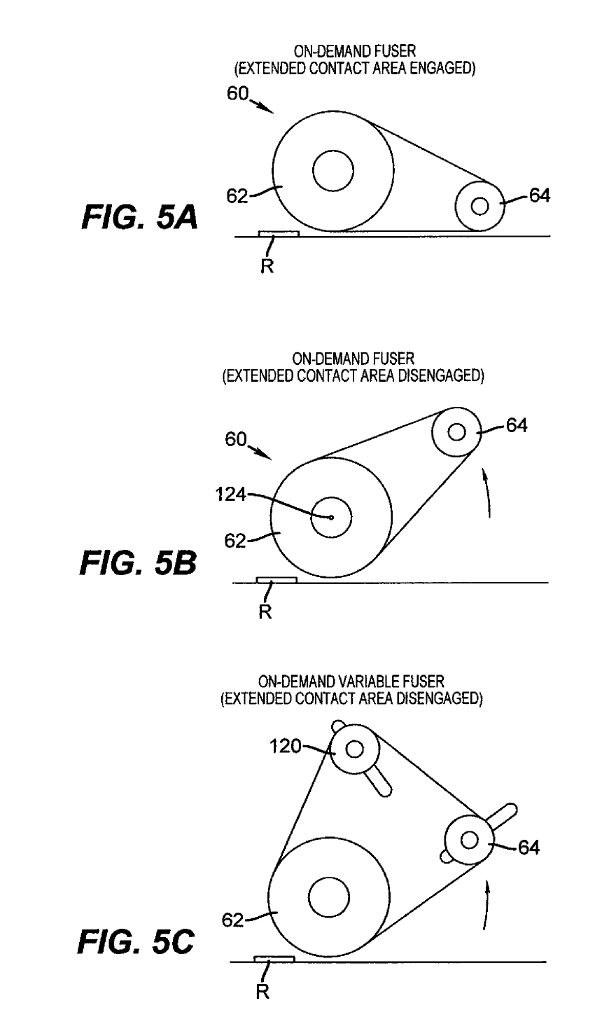

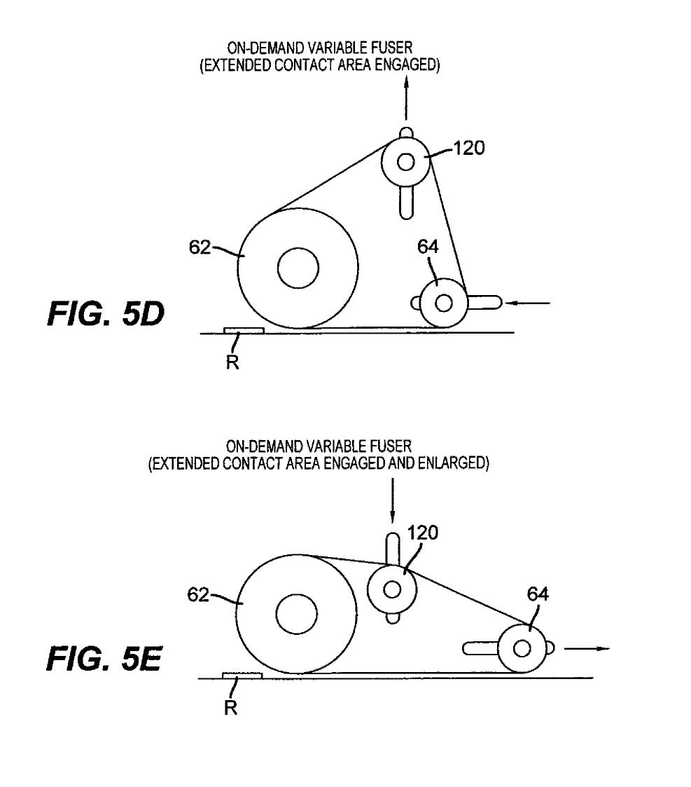

FIG. 5 shows a portion of the on-demand fuser 60 as it could be in various alternate embodiments that use the variable cooling contact area portion of the fuser to perform a variety of useful functions including those discussed above. FIG. 5a shows the on demand fuser 60 in the photo-centric position A discussed above where the cooling contact area is engaged (see FIG. 5a) and can be lengthened using a sliding structure similar to the sliding structure described above in conjunction with FIG. 3. If more cooling is desired by increasing the length of the belt to use in the photo-centric mode discussed above. A variable length belt or one that is elastic could be used to accomplish this lengthening. Other devices can be used to change the length of the belt, in conjunction with a controller and an energy source, such as a movable roller or other movable elements known to those skilled in the art.

FIG. 5b shows the document-centric mode or the text and graphics mode, as shown as position B in FIG. 4. The position B is a position where the printer only utilizes the heating zone since the cooling zone is not necessary so the variable cooling contact area is disengaged in the text and graphics mode. This embodiment could vary the contact area a small amount but would not engage the cooling portion of the on-demand fuser.

FIGS. 5c, 5d and 5e show other embodiments that vary the cooling contact area by changing the cooling length and the engagement by adding one or more rollers 120. Using a short length contact area instead of a longer length one would result in a lower gloss level. The on-demand fuser support roller 62 can pivot about a pivot point 124 when the one or more extra roller 120 is moved, such as through a spring or mechanical action, controllable by a controller 126, that adjusts both the film relative location as well as its length by pulling up some of the film and shortening the exposable surface that will be in contact with the receiver. FIG. 5c shows the on-demand variable fuser with the extended contact area disengaged while FIG. 5d on-demand variable fuser with the extended contact area engaged with the receiver. FIG. 5e shows the on-demand variable fuser with the extended contact area engaged and enlarged compared to the position in FIG. 5d. One skilled in the art understands that there are many variables available with this arrangement of sliding structures or rollers as described above. Each can be an incremental difference from another such that the user can choose, such by an adjustment device 128 connected to the controller and/or the on-demand fuser that enables the user to carefully control the surface gloss and/or finish of the final print.

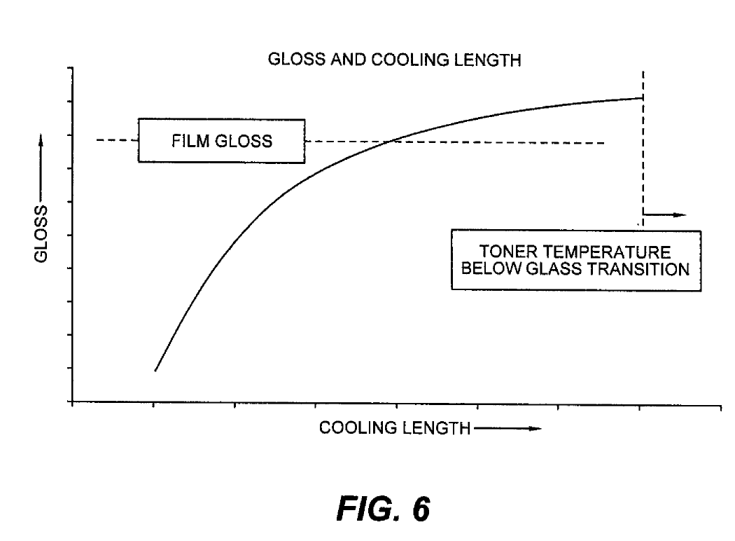

FIG. 6 shows a graph of the relationship between gloss and cooling length. The gloss level is shown to increase as the cooling length Lc in zone 108 increases. Film gloss is a function of the gloss and can be controlled by this relationship, which is controlled, by the controller 126 as shown in FIG. 1 (LCU) and/or sensors by changing one or more of the cooling length by adjustments as shown in FIG. 5.

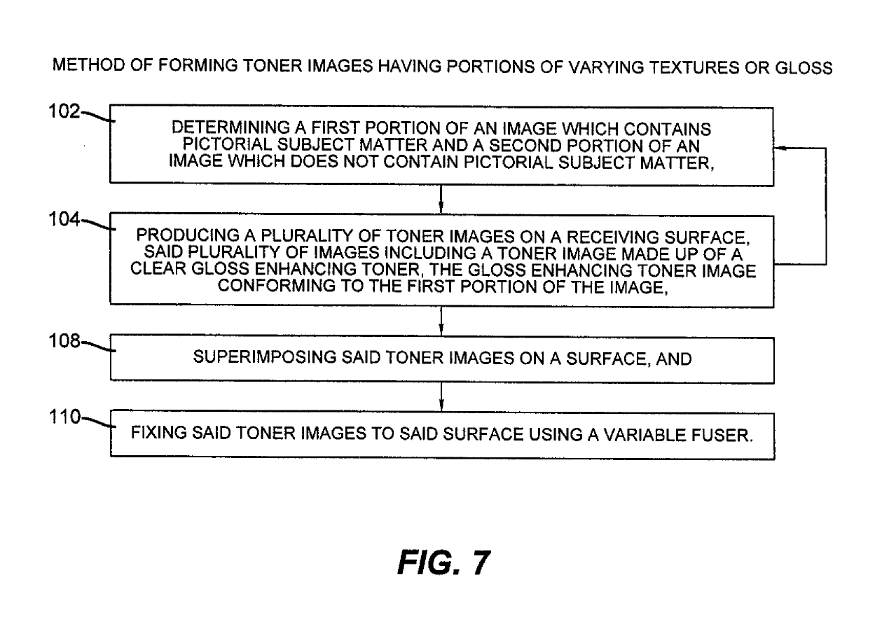

FIG. 7 shows a method that uses the variable cooling contact area portion of the fuser. The method of variable gloss fusing while forming toner images having portions of varying textures or gloss starts by determining 200 of a first portion of an image I₁ which contains pictorial subject matter and a second portion of an image I₂ which does not contain pictorial subject matter and together can be a plurality of images Iₙ. The texture or gloss applied includes a type of gloss finish referred to as spot gloss or varnish that covers particular spots of the total surface to give a desired effect, such as a spot of color over any picture that is to stand out, say over the text in the print. Spot gloss is also useful for security printing and for giving various visual effects such as additional brightness or variable brightness. The effect of varying brightness could be used to highlight text that is to stand out in a sales brochure, such as personalized names and places. The imaging device produces 202 the plurality of toner images on the receiving surface so that toner image is made up of clear gloss enhancing toner conforming to the first portion of the image I₁ by superposing said toner on the images 208 and fixing 210 the toner to the receiver using the variable surface on-demand fuser 60.

The invention has been described in detail with particular reference to certain preferred embodiments thereof, but it will be understood that variations and modifications can be effected within the spirit and scope of the invention. This invention is inclusive of combinations of the embodiments described herein. References to a “particular embodiment” and the like refer to features that are present in at least one embodiment of the invention. Separate references to “am embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like are not limiting

1. An electrostatographic printer for on demand fusing with a fusing apparatus comprising:
a. a variable fusing member comprising a variable contact area for fusing toner to sheets of receiver media;
b. one or more support members in contact with said heated fusing member such that the contact member is capable of changing said fuser contact area; and
c. a pressure member in contact with the heated fusing member to form a fusing nip therebetween.

2. The apparatus of claim 1, wherein said variable fusing member comprise heating elements.

3. The apparatus of claim 1, wherein said fusing member comprise one of a roller, a static sliding member or a rod.

4. The apparatus of claim 1, wherein said one or more support members comprise one or more of a roller, a static sliding member or a rod.

5. The apparatus of claim 1, wherein said fuser contact area of said variable fusing member is determined by a suitable manual input or electronic analysis of the image.

6. The apparatus of claim 1, further comprising a machine controller for changing fusing nip widths and the fuser contact area in accordance with the type of receiver media and the image on the media.

7. The apparatus of claim 6, further comprising a support member controller associated with the machine controller, for changing contact between the heated fusing member and the receiver.

8. The apparatus of claim 6, further comprising a pressure member nip controller associated with the machine controller, for changing nip width between the pressure member and the heated fusing member.

9. The apparatus of claim 1, wherein said variable contact area comprises a heating area.

10. The apparatus of claim 1, wherein said variable contact area comprises an active cooling area comprising one or more of a thermoelectric device, a forced air device, a vapor cooling device or a vapor cooling device in combination with a thermoelectric device.

11. The apparatus of claim 1, wherein said variable contact area comprises an passive cooling area comprising one or more of a free convection area, a heat-sink structure with free convection or a finned heat-sink structure with free convection.

12. An electrostatographic printer for on demand fusing with a fusing apparatus comprising:
a. a variable heating fusing member comprising a variable contact area for fusing toner to sheets of receiver media;
b. one or more support members in contact with said heated fusing member such that the contact member is capable of changing said fuser contact area;
c. a pressure member in contact with the heated fusing member to form a fusing nip therebetween; and
d. a variable fusing gloss selection device.

13. The apparatus of claim 11, wherein said variable fusing gloss selection device comprises a suitable manual input or electronic analysis of the image to allow one or more of a flood gloss, a spot gloss or differential gloss.

14. The apparatus of claim 11, wherein said fusing member comprise one of a roller, a static sliding member or a rod.

15. The apparatus of claim 11, wherein said one or more support members comprise one or more of a roller, a static sliding member or a rod.

16. The apparatus of claim 11, wherein said fuser contact area of said variable fusing member is determined by a suitable manual input or electronic analysis of the image.

17. The apparatus of claim 11, further comprising a machine controller for changing fusing nip widths and the fuser contact area in accordance with the type of receiver media and the image on the media.

18. The apparatus of claim 16, further comprising a support member controller associated with the machine controller, for changing contact between the heated fusing member and the receiver.

19. The apparatus of claim 16, further comprising a pressure member nip controller associated with the machine controller, for changing nip width between the pressure member and the heated fusing member.

20. The apparatus of claim 16, wherein said variable contact area comprises a heating area.

21. The apparatus of claim 16, wherein said variable contact area comprises an active cooling area comprising one or more of a thermoelectric device, a forced air device or a vapor cooling device.

22. A method of forming toner images having portions of varying surface finishes, said method comprising:
determining a first portion of an image and a second portion of an image to be printed with non-clear toner on a receiving surface,
producing a plurality of toner images including both non-clear and clear toner images where at least one clear toner image is in registration with one non-clear image on the receiving surface, said plurality of toner images including a clear gloss enhancing toner for the clear toner such that the gloss enhancing toner image conforming to at least one image portion,
superposing said clear toner images on the receiver in registration with the image portion, and
fixing said toner images to said surface using a variable fuser.

23. A method of claim 22, said method further comprising:
a first portion of an image, which contains pictorial subject matter and a second portion of an image, which does not contain pictorial subject matter.

24. A method of claim 22, said surface finishes further comprising a textures or gloss finish.

25. A method of claim 22 wherein said surface finishes further comprising a spot gloss finish.
